(19) United States
(12) Patent Application Publication
(10) Pub. No.: US 2025/0131277 A1
(43) Pub. Date: Apr. 24, 2025

(54) CONTROL NEURAL NETWORK INFERENCE AND TRAINING BASED ON DISTILLED GUIDED DIFFUSION MODELS

(71) Applicant: QUALCOMM Incorporated, San Diego, CA (US)

(72) Inventors: Risheek GARREPALLI, San Diego, CA (US); Shubhankar Mangesh BORSE, San Diego, CA (US); Jisoo JEONG, San Diego, CA (US); Qiqi HOU, San Diego, CA (US); Shreya KADAMBI, San Diego, CA (US); Munawar HAYAT, San Diego, CA (US); Fatih Murat PORIKLI, San Diego, CA (US)

(21) Appl. No.: 18/492,529

(22) Filed: Oct. 23, 2023

(51) Int. Cl. G06N 3/09

(52) U.S. Cl. CPC G06N 3/09

(57) ABSTRACT

A method for training a control neural network includes initializing a baseline diffusion model for training the control neural network, each stage of a control neural network training pipeline corresponding to an element of the baseline diffusion model. The method also includes training, the control neural network, in a stage-wise manner, each stage of the control neural network training pipeline receiving an input from a previous stage of the control neural network training pipeline and the corresponding element of the diffusion model.

### FIELD OF THE DISCLOSURE

Aspects of the present disclosure generally relate to improving training and inference of a control neural network by incorporating a distilling guided diffusion models.

### BACKGROUND

Artificial neural networks may comprise interconnected groups of artificial neurons (e.g., neuron models). The artificial neural network (ANN) may be a computational device or be represented as a method to be performed by a computational device. Convolutional neural networks (CNNs) are a type of feed-forward ANN. Convolutional neural networks may include collections of neurons that each have a receptive field and that collectively tile an input space. Convolutional neural networks, such as deep convolutional neural networks (DCNs), have numerous applications. In particular, these neural network architectures are used in various technologies, such as image recognition, speech recognition, acoustic scene classification, keyword spotting, autonomous driving, and other classification tasks.

In machine learning and data generation, diffusion refers to an approach used by generative models to transform data through a sequence of invertible transformations. These generative models may be referred to as diffusion models. During a diffusion process, the diffusion model starts with a distribution, typically a Gaussian distribution, and gradually transforms the data into a desired data distribution, thus facilitating tasks, such as image synthesis and denoising. Diffusion models demand substantial computational resources, such as power, memory, and/or processor load, resulting in tradeoffs between training time and a quality of generated data.

### SUMMARY

Some aspects of the present disclosure are directed to a method for training a diffusion model includes compressing the diffusion model by removing one or more model parameters and/or one or more giga multiply-accumulate operations (GMACs). The method further includes performing guidance conditioning to train the compressed diffusion model, the guidance conditioning combining a conditional output and an unconditional output from respective teacher models. The method also includes performing, after the guidance conditioning, step distillation on the compressed diffusion model.

Some other aspects of the present disclosure are directed to an apparatus including means for compressing the diffusion model by removing one or more model parameters and/or one or more GMACs. The apparatus further includes means for performing guidance conditioning to train the compressed diffusion model, the guidance conditioning combining a conditional output and an unconditional output from respective teacher models. The apparatus also includes means for performing, after the guidance conditioning, step distillation on the compressed diffusion model.

In some other aspects of the present disclosure, a non-transitory computer-readable medium with non-transitory program code recorded thereon is disclosed. The program code is executed by a processor and includes program code to compress the diffusion model by removing one or more model parameters and/or one or more GMACs. The program code further includes program code to perform guidance conditioning to train the compressed diffusion model, the guidance conditioning combining a conditional output and an unconditional output from respective teacher models. The program code also includes program code to perform, after the guidance conditioning, step distillation on the compressed diffusion model.

Additionally, some other aspects of the present disclosure are directed to an apparatus having one or more processors and one or more memories coupled with the one or more processors and storing instructions operable, when executed by the one or more processors, to cause the apparatus to compress the diffusion model by removing one or more model parameters and/or one or more GMACs. Execution of the instructions also cause the apparatus to perform guidance conditioning to train the compressed diffusion model, the guidance conditioning combining a conditional output and an unconditional output from respective teacher models. Execution of the instructions further cause the apparatus to perform, after the guidance conditioning, step distillation on the compressed diffusion model.

In some aspects of the present disclosure, a method for training a diffusion model includes randomly selecting, for each iteration of a step distillation training process, a teacher model of a group of teacher models. The method further includes applying, at each iteration, a clipped input space within step distillation of the randomly selected teacher model. The method also includes updating, at each iteration, parameters of the diffusion model based on guidance from the randomly selected teacher model.

Some other aspects of the present disclosure are directed to an apparatus including means for randomly selecting, for each iteration of a step distillation training process, a teacher model of a group of teacher models. The apparatus further includes means for applying, at each iteration, a clipped input space within step distillation of the randomly selected teacher model. The apparatus also includes means for updating, at each iteration, parameters of the diffusion model based on guidance from the randomly selected teacher model.

In some other aspects of the present disclosure, a non-transitory computer-readable medium with non-transitory program code recorded thereon is disclosed. The program code is executed by a processor and includes program code to randomly select, for each iteration of a step distillation training process, a teacher model of a group of teacher models. The program code further includes program code to apply, at each iteration, a clipped input space within step distillation of the randomly selected teacher model. The program code also includes program code to update, at each iteration, parameters of the diffusion model based on guidance from the randomly selected teacher model.

Additionally, some other aspects of the present disclosure are directed to an apparatus having one or more processors and one or more memories coupled with the one or more processors and storing instructions operable, when executed by the one or more processors, to cause the apparatus to randomly select, for each iteration of a step distillation training process, a teacher model of a group of teacher models. Execution of the instructions also cause the apparatus to apply, at each iteration, a clipped input space within step distillation of the randomly selected teacher model. Execution of the instructions further cause the apparatus to update, at each iteration, parameters of the diffusion model based on guidance from the randomly selected teacher model.

In some aspects of the present disclosure, a method for training a control neural network includes initializing a baseline diffusion model for training the control neural network, each stage of a control neural network training pipeline corresponding to an element of the baseline diffusion model. The method still further includes training, the control neural network, in a stage-wise manner, each stage of the control neural network training pipeline receiving an input from a previous stage of the control neural network training pipeline and the corresponding element of the diffusion model.

Some other aspects of the present disclosure are directed to an apparatus including means for initializing a baseline diffusion model for training the control neural network, each stage of a control neural network training pipeline corresponding to an element of the baseline diffusion model. The apparatus further includes means for training, the control neural network, in a stage-wise manner, each stage of the control neural network training pipeline receiving an input from a previous stage of the control neural network training pipeline and the corresponding element of the diffusion model.

In some other aspects of the present disclosure, a non-transitory computer-readable medium with non-transitory program code recorded thereon is disclosed. The program code is executed by a processor and includes program code to initialize a baseline diffusion model for training the control neural network, each stage of a control neural network training pipeline corresponding to an element of the baseline diffusion model. The program code still further includes program code to train, the control neural network, in a stage-wise manner, each stage of the control neural network training pipeline receiving an input from a previous stage of the control neural network training pipeline and the corresponding element of the diffusion model.

Additionally, some other aspects of the present disclosure are directed to an apparatus having one or more processors and one or more memories coupled with the one or more processors and storing instructions operable, when executed by the one or more processors, to cause the apparatus to initialize a baseline diffusion model for training the control neural network, each stage of a control neural network training pipeline corresponding to an element of the baseline diffusion model. Execution of the instructions further cause the apparatus to train, the control neural network, in a stage-wise manner, each stage of the control neural network training pipeline receiving an input from a previous stage of the control neural network training pipeline and the corresponding element of the diffusion model.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with aspects of the present disclosure.

FIG. 2D is a diagram illustrating an exemplary deep convolutional network (DCN) in accordance with aspects of the present disclosure.

FIG. 3 is a block diagram illustrating an exemplary deep convolutional network (DCN) in accordance with aspects of the present disclosure.

FIG. 4 is a block diagram illustrating an exemplary software architecture that may modularize artificial intelligence (AI) functions, in accordance with aspects of the present disclosure.

FIG. 5 is a block diagram illustrating an example of a training pipeline for training a diffusion model, in accordance with various aspects of the present disclosure.

FIG. 6A is a block diagram illustrating a first variant of an efficient architecture for diffusion-based generative models, in accordance with various aspects of the present disclosure.

FIG. 6B is a block diagram illustrating a second variant of an efficient architecture for diffusion-based generative models, in accordance with various aspects of the present disclosure.

FIG. 7 is a block diagram illustrating an example of guidance conditioning, in accordance with various aspects of the present disclosure.

FIG. 8 is a block diagram illustrating an example of step distillation, in accordance with various aspects of the present disclosure.

FIG. 9 is a block diagram illustrating an example of a step distillation process, in accordance with various aspects of the present disclosure.

FIG. 10 is a block diagram of a ControlNet architecture, in accordance with various aspects of the present disclosure.

FIG. 11 is a block diagram illustrating an example of a ControlNet training pipeline, in accordance with various aspects of the present disclosure.

FIG. 12 is a flow diagram illustrating an example of a process for training a stable diffusion model, in accordance with various aspects of the present disclosure.

FIG. 13 is a flow diagram illustrating an example of a process for a classifier free guidance (CFG)-aware step distillation process, in accordance with various aspects of the present disclosure.

FIG. 14 is a flow diagram illustrating an example of a process for training a control neural network model, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

In machine learning and data generation, diffusion refers to an approach used by generative models to morph data through a chain of invertible transformations. These generative models, which may be referred to as diffusion models, initiate with a distribution, typically a Gaussian distribution, and progressively transform data into a desired data distribution. This progression aids in executing tasks, such as image synthesis and denoising, which are associated with various applications, including, but not limited to, digital media enhancement, medical imaging, and autonomous systems. However, diffusion models may use a large amount of computational resources, such as, but not limited to, power, memory, and/or processor load, resulting in tradeoffs between training time and a quality of generated data. In some cases, the training time may be dependent on an exact sequence of training stages, loss functions, and/or model initialization.

It may be desirable to reduce an amount of computational resources used by a diffusion model. Various aspects of the present disclosure are directed to reducing an inference time of a diffusion model. The inference time refers to a time between receiving an input and generating a final output from the diffusion model. Some aspects are also directed to reducing an inference time of a ControlNet model.

In some examples, a diffusion model (e.g., stable diffusion) training pipeline is specified to reduce the inference time. The training pipeline may include a novel UNet architecture with reduced giga multiply-accumulate operations (GMACs) and model parameters, thereby reducing memory usage and other computational resources. This UNet architecture acts as a leaner engine, delivering similar or better performance to conventional convolutional network architectures, while consuming fewer resources.

Moreover, the training pipeline also includes a guidance conditioning block that uses conditional and unconditional generation to train a student model, effectively doubling the speed of data generation. This guidance conditioning not only accelerates the generation process but also preserves the integrity and quality of the generated data. In some examples, an unconditional training approach is used for guidance conditioning as well as step distillation with dropout, such that the student model remains in harmony with a teacher model across all training stages. This alignment may prevent mode collapse.

Finally, the training pipeline includes a step distillation block to reduce a number of UNet forward passes. For example, the number of forward passes may be reduced from approximately forty forward passes to six forward passes, which decreases training time. In some examples, the step distillation may clip an input space.

In some examples, one or more training blocks of the stable diffusion training pipeline may be used for a control neural network, such as a ControlNet, training pipeline. In some examples, the UNet architecture may be used to train the control neural network. Furthermore, the guidance conditioning and the step distillation may be applied to the control neural network.

These strategic enhancements in the training process of diffusion models, inspired by the realm of efficient UNet architecture, guidance conditioning, and step distillation, reduce computational demands while retaining, if not enhancing, the quality of generated data. Particular aspects of the subject matter described in this disclosure can be implemented to realize one or more of the following potential advantages. In some examples, the training pipeline, including the UNet architecture, guidance conditioning, and step distillation, may reduce an amount of computational resources used by a diffusion model and/or control neural network model, thereby reducing a respective inference time of the diffusion model and/or control neural network model.

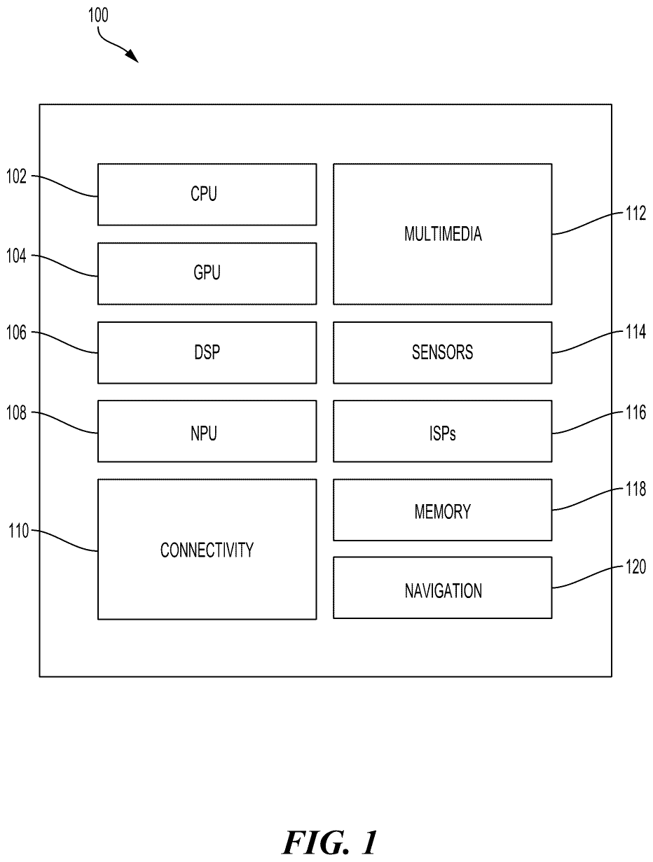

FIG. 1 illustrates an example implementation of a system-on-a-chip (SOC) 100, which may include a central processing unit (CPU) 102 or a multi-core CPU configured for training a stable diffusion model, implementing the stable diffusion model, training a ControlNet model, and/or implementing the ControlNet model. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

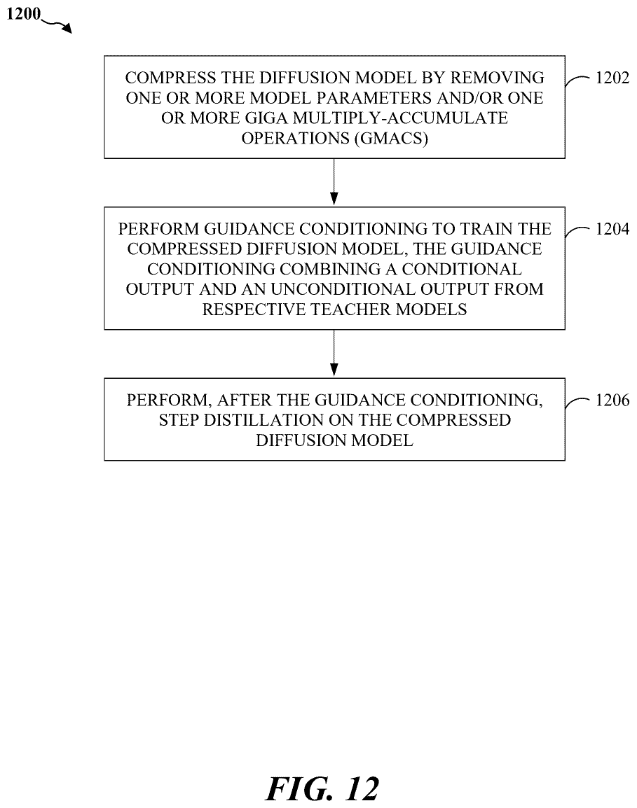

The SOC 100 may be based on an ARM instruction set. In aspects of the present disclosure, the instructions loaded into the general-purpose processor 102 may include code to perform operations, such as one or more operations of the processes 1200, 1300, and/or 1400 described with reference to FIGS. 12, 13, and 14, respectively.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

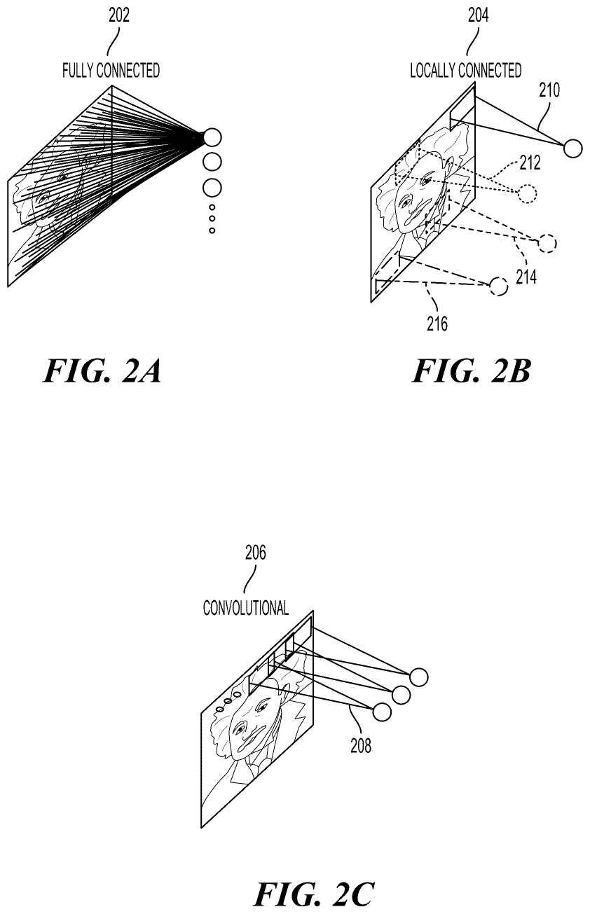

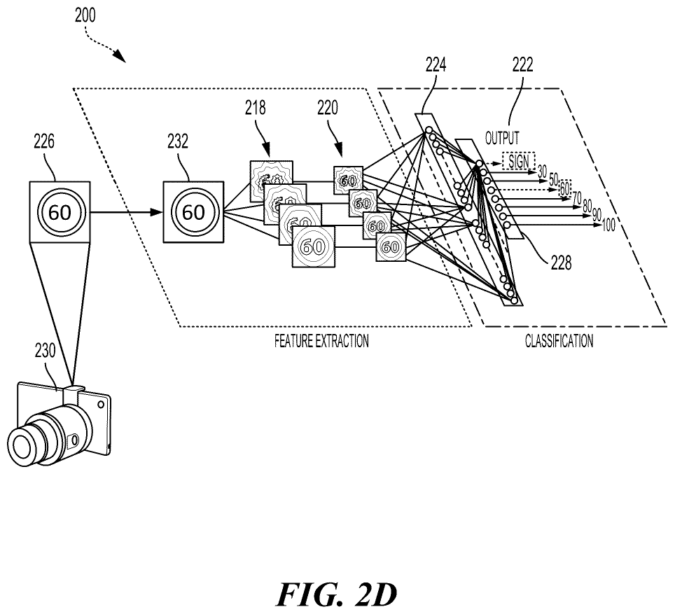

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images (e.g., the speed limit sign of the image 226) and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

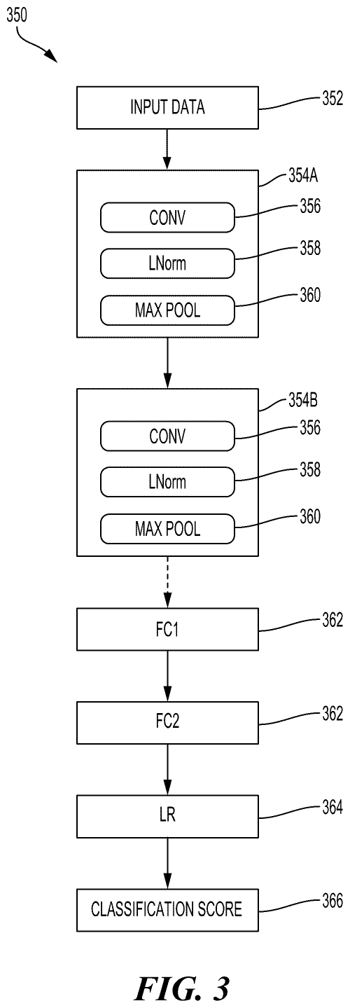

FIG. 3 is a block diagram illustrating a DCN 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

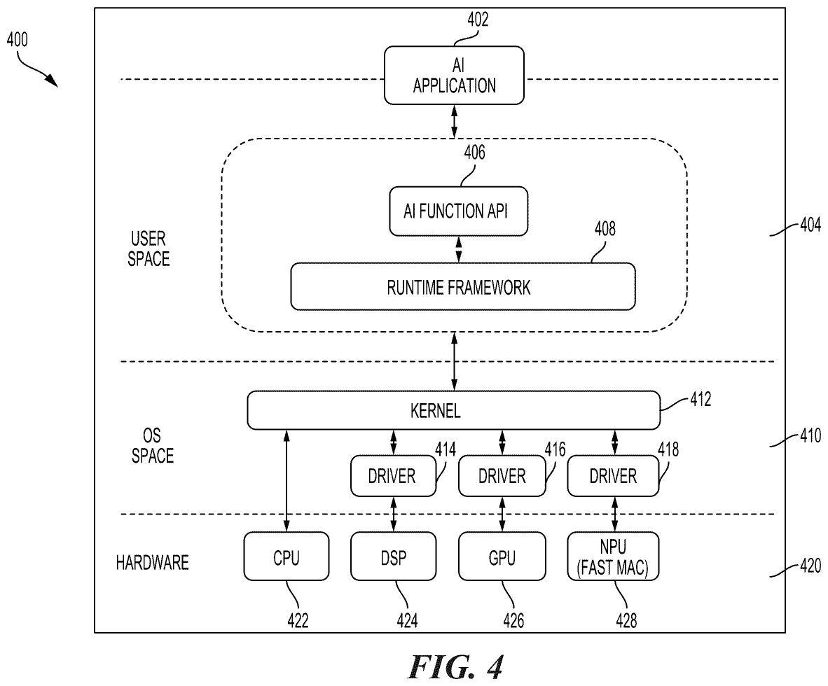

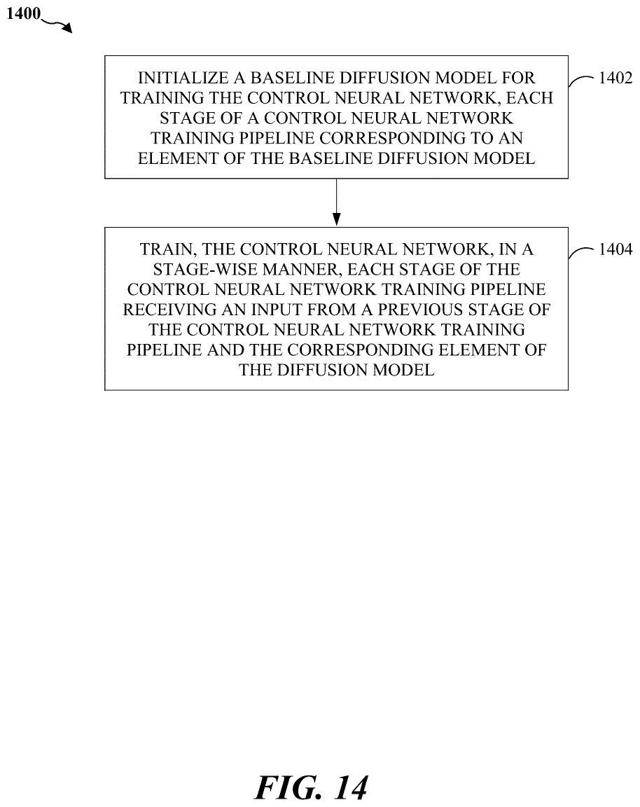

FIG. 4 is a block diagram illustrating an exemplary software architecture 400 that may modularize artificial intelligence (AI) functions. Using the architecture 400, applications may be designed that may cause various processing blocks of an SOC 420 (for example a CPU 422, a DSP 424, a GPU 426 and/or an NPU 428) (which may be similar to SOC 100 of FIG. 1) to support one or more operations, such as one or more operations of one or more of the processes 1200, 1300, or 1400 described with reference to FIG. 14 and/or one or more operations of an AI application 402, according to various aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

The run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

In machine learning and data generation, diffusion refers to an approach used by generative models to morph data through a chain of invertible transformations. These generative models, which may be referred to as diffusion models, initiate with a distribution, typically a Gaussian distribution, and progressively transform data into a desired data distribution. This progression aids in executing tasks, such as image synthesis and denoising, which are associated with various applications, including, but not limited to, digital media enhancement, medical imaging, and autonomous systems. The transformations are designed to be invertible, meaning they can be reversed. This feature allows the diffusion model to learn how to generate new data by running the transformation process in reverse. During a forward process (from simple to complex distribution), noise is added at each step, diffusing the data further. During the reverse process (from complex distribution to generated data), noise is progressively removed at each step, gradually refining the generated data to resemble real data. The diffusion model may be trained by adjusting its parameters to minimize the difference between the generated data and the real data. This training process may use a set of real data to serve as a reference. Once trained, the diffusion model can generate new data by starting with a sample from the initial simple distribution and applying the learned transformations in reverse, removing noise step by step to produce realistic data.

Examples of tasks performed by diffusion models include text-to-image generation, as well as image or video editing. Solutions from a diffusion model may be used for cameras (e.g., video cameras), and personal computing for image or video generation and editing. Diffusion models may also efficiently generate synthetic image data for training deep learning models, may be used for autonomous driving, as well as for extended reality (XR), augmented reality (AR), and virtual reality (VR) applications.

Diffusion-based generative models, for example, Stable Diffusion developed by STABILITY AI, ImageGen developed by GOOGLE, VideoLDM developed by NVIDIA and FireFly developed by ADOBE are computationally expensive. For example, iterative denoising requires multiple forward passes of a neural network for each generation. The neural network may be a UNet architecture, which is so named because of the u-shape of the network, including a down sampling path and an up sampling path.

Diffusion models may use a large amount of computational resources, such as, but not limited to, power, memory, and/or processor load, resulting in tradeoffs between training time and a quality of generated data. In most cases, training diffusion models demand substantial computational resources, both in terms of data and training time. In some cases, the training time may be dependent on an exact sequence of training stages, loss functions, and/or model initialization.

Various aspects of the present disclosure are directed to reducing an inference time of a diffusion model. The inference time refers to a time between receiving an input and generating a final output from the diffusion model. Some aspects are also directed to reducing an inference time of a ControlNet model. In some examples, a diffusion model (e.g., stable diffusion) training pipeline is specified to address various aspects of overall loss functions and to improve efficiency, in terms of training time and inference time.

Some conventional training systems are directed to simplifying a model's structure or reducing a number of training steps. Various aspects of the present disclosure are directed to simplifying the diffusion model while also reducing the number of training steps. Such aspects may reduce training time without sacrificing inference accuracy (e.g., quality). This dual approach of simplifying the model while also reducing the steps in training distinguishes the various aspects of the present disclosure from conventional training processes.

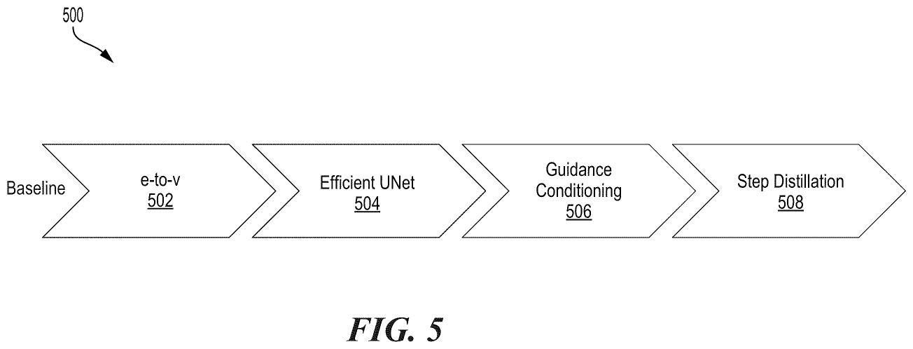

FIG. 5 is a block diagram illustrating an example of a training pipeline 500 for training a diffusion model, in accordance with various aspects of the present disclosure. The training pipeline 500 may also be referred to as a stable diffusion training pipeline 500. In various aspects of the present disclosure, the sequence of the training pipeline 500, as shown in the example of FIG. 5, is specified to reduce training time and inference time. As shown in the example of FIG. 5, the training pipeline 500 begins at block 502 with an E-to-v block. In most stable diffusion cases, the diffusion model inherently predicts epsilon (ε), which represents the delta noise, while a parameter v represents velocity. In some other models, the prediction can directly be the data itself at each stage of the diffusion process. In such examples, the diffusion model is transitioning from an epsilon space to a velocity space, as the velocity space offers a greater signal-to-noise ratio, which may be beneficial for step distillation. This transition aids in improving the diffusion model's performance. The e-to-v block 502 is a form of rescaling or reparameterization of an output.

The parameter ε represents a noise term in the diffusion process. The velocity v is a measure of how fast the diffusion process is moving in a certain direction. In the context of diffusion, ε may be random fluctuations or noise that drives the diffusion process. The diffusion processes velocity v may be determined based on a function of the noise ε and a position x. For example, v_{ϕ}=cos(ϕ)ε−sin(ϕ)ε, where ϕ represents a current angle. The angle ϕ defines the direction and magnitude of the noise ε and the position x. That is, as the angle ϕ changes, the contribution of the noise and the position x to the velocity v changes, allowing the diffusion process to move in different directions and at different speeds.

At block 504, a UNet architecture is used to process an output of the e-to-v block 502. The UNet architecture is so named because of the u-shape of the network, which includes a down sampling path and an up sampling path. UNet architectures in conventional state-of-the-art (SOTA) models adopt a combination of attention layers and convolutional layers at each stage of the UNet. Conventional UNet architectures adopt global self-attention and cross-attention operations at all spatial resolutions. Attention operations consume significant compute and memory resources making edge device inference challenging and on-device generative artificial intelligence (AI) inference challenging.

Aspects of the present disclosure introduce hardware efficient architectures for machine learning diffusion-based generative models. In some aspects, the hardware efficient architectures are efficient UNet architectures. According to aspects of the present disclosure, a convolution only block is adopted for a first stage of a UNet. Consequently, cross-attention is not adopted to process text or image information for low-level features at the first stage having the highest resolution of the network. Because high resolution blocks mostly recover low-level details, global self-attention is not adopted in these blocks with the highest resolution (e.g., the first stage of the architecture.)

Two variants of efficient architectures with minimal attention layers are introduced. In both architectures, text semantics are injected only for 32×32 and lower spatial resolutions. That is, a convolution only block is provided for the first stage of the UNet architecture. In the first variant, two convolution blocks are provided in the down sampling portion of the network and three convolution blocks are provided in the up sampling portion. The second variant builds on top of the first variant architecture, and further adopts one fewer block of convolution per stage.

At block 506, guidance conditioning is specified. Guidance conditioning, in the context of stable diffusion, involves a process where, for each denoising step or iteration, two UNets are executed, one incorporating text embedding (with conditioning) and the other excluding text embedding (without conditioning). Guidance conditioning streamlines the training process by reducing the training to just one UNet forward pass, aiming to preserve the same quality of output. Thus, through a single forward pass, the diffusion model maintains a quality that would be achieved with two forward passes in conventional systems.

At block 508, step distillation decreases a number of denoising iterations, or steps, throughout the inference process. Some conventional systems use step distillation as a preprocessing step to refine a loss. In contrast, various aspects of the present disclosure incorporate architectural compression alongside step distillation and guidance conditioning.

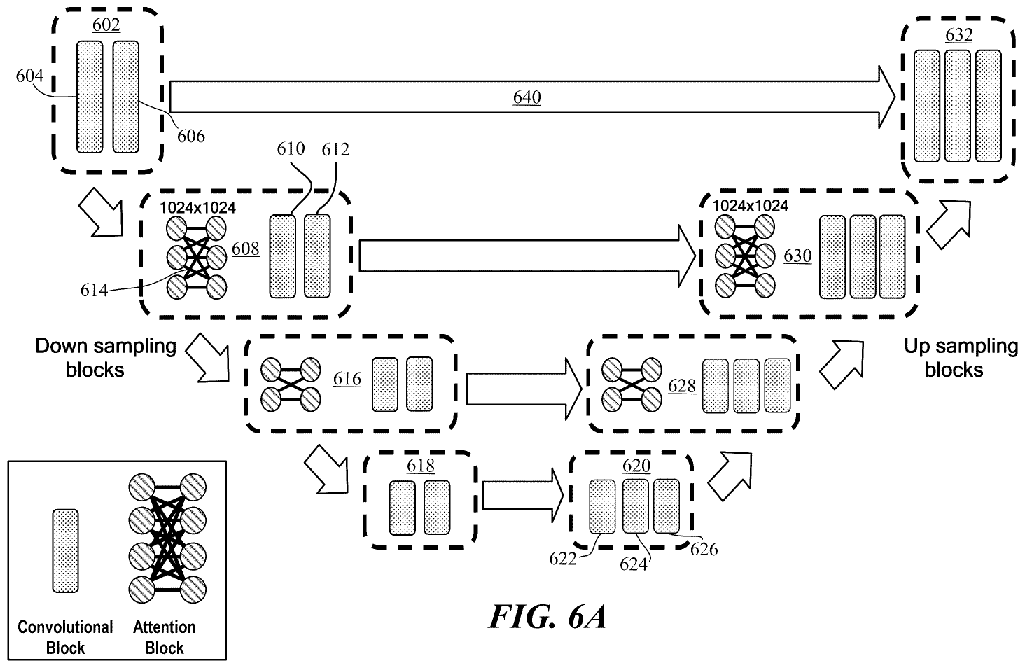

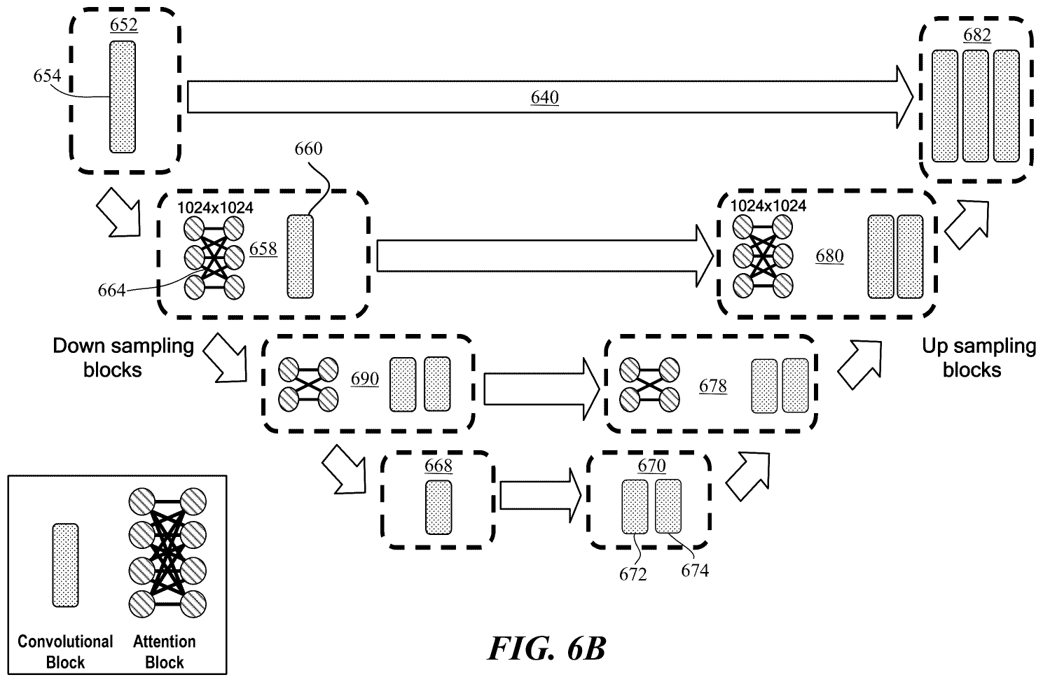

As shown in the example of FIG. 5, the architecture of the diffusion model may be compressed by using a UNet architecture (block 504). FIG. 6A is a block diagram illustrating a first variant of an efficient architecture for diffusion-based generative models, in accordance with various aspects of the present disclosure. The architecture shown in FIG. 6A is an example of a UNet. In the architecture shown in FIG. 6A, a first stage 602 receives a text-semantic input. In the example of FIG. 6A, the first stage 602 is a 64×64 input stage, although the present disclosure is not limited to any such resolution. The first stage 602 includes two convolutional blocks 604, 606. The first stage 602 does not include any self-attention or cross-attention layers. A second stage 608 has a lower resolution than the first stage 602 for down sampling the feature map generated at the first stage 602. For example, the second stage 608 may have a 32×32 resolution. The second stage 608 includes two convolutional blocks 610, 612, and also attention layers 614. For example, the attention layers 614 may be a 1024×1024 self-attention and/or cross-attention layer. The attention layers 614 inject the text-semantic input into the second stage 608.

A third stage 616 may also include two convolutional blocks and attention layers (not separately labeled). The third stage 616 and the attention layers of the third stage 616 have lower resolutions than the second stage 608. For example, the third stage 616 may have a 16×16 spatial resolution and the attention layers in the third stage 616 may be 256×256. A fourth stage 618, also referred to as a midblock, includes two convolutional blocks (not separately labeled) and no attention layers. The fourth stage 618 may have a spatial resolution of 8×8. The second, third, and fourth stages 608, 616, 618 may be referred to as down sampling stages or down sampling blocks of the network architecture.

Up sampling stages (or up sampling blocks) of the architecture include a fifth, sixth, and seventh stage 620, 628, 630 in the example of FIG. 6A. The fifth stage 620 may also be referred to as a midblock and includes three convolutional blocks 622, 624, 626. A spatial resolution of the fifth stage 620 may be 8×8. The sixth stage 628 includes three convolutional blocks and an attention layer (not separately labeled). Similarly, the seventh stage 630 includes three convolutional blocks and an attention layer (not separately labeled). The sixth and seventh stages 628, 630 may have respective resolutions of 16×16, and 32×32. An eighth stage 632 is an output layer and includes three convolutional blocks (not separately labeled) and no attention layers. Thus, it can be seen that attention is only provided in stages having a resolution of 32×32 or lower. Each stage, with two blocks of convolutional, self-attention and cross-attention per stage, offers good capacity to retain information and ease optimization.

Not only does each stage receive input from an immediately preceding stage, but each up sampling stage also receives input from a corresponding stage on the down sampling side via a skip connection. For example, the output stage, e.g., the eighth stage 632, receives input from both the first stage 602 (via a skip connection 640) and also from the seventh stage 630. It is noted that the second midblock (e.g., fifth stage 620) receives input from the fourth stage 618 without any additional input. The efficient architecture shown in FIG. 6A reduces on-device latency, with little impact on generation quality, compared with a baseline model.

FIG. 6B is a block diagram illustrating a second variant of an efficient architecture for diffusion-based generative models, in accordance with various aspects of the present disclosure. The second variant shown in FIG. 6B builds on top of the architecture shown in FIG. 5, and may be referred to as a pruned version of variation one. The second variant adopts one fewer block of convolution, self-attention and cross-attention per down sampling stage (excluding the input stage). In the architecture shown in FIG. 6B, a first stage 652 receives a text-semantic input. In the example of FIG. 6B, the first stage 652 is a 64×64 input stage, although the present disclosure is not limited to any such resolution. The first stage 652 includes one convolutional block 654. The first stage 652 does not include any self-attention or cross-attention layers. A second stage 658 has a lower resolution than the first stage 652 for down sampling the feature map of the first stage 652. For example, the second stage 658 may have a 32×32 resolution. The second stage 658 includes one convolutional block 660, and also attention layers 664. For example, the attention layers 664 may be a 1024×1024 self-attention and/or cross-attention layer. The attention layers 664 inject the text-semantic input into the second stage 658.

A third stage 690 may also include one convolutional block and attention layers (not separately labeled). The third stage 690 and the attention layers of the third stage 690 have lower resolutions than the second stage 658. For example, the third stage 690 may have a 16×16 spatial resolution and the attention layers in the third stage 690 may be 256×256. A fourth stage 668, also referred to as a midblock, includes one convolutional block (not separately labeled) and no attention layers. The fourth stage 668 may have a spatial resolution of 8×8. The second, third, and fourth stages 658, 690, 668 may be referred to as down sampling stages or down sampling blocks of the network architecture.

Up sampling stages (or up sampling blocks) of the architecture include a fifth, sixth, and seventh stage 670, 678, 680 in the example of FIG. 6B. The fifth stage 670 may also be referred to as a midblock and includes two convolutional blocks 672, 674. A spatial resolution of the fifth stage 670 may be 8×8. The sixth stage 678 includes two convolutional blocks and attention layers (not separately labeled). Similarly, the seventh stage 680 includes two convolutional blocks and attention layers (not separately labeled). The sixth and seventh stages 678, 680 may have respective resolutions of 16×16, and 32×32. An eighth stage 682 is an output layer and includes two convolutional blocks (not separately labeled) and no attention layers. Thus, it can be seen that attention is only provided in stages having a resolution of 32×32 or lower.

Not only does each stage receive input from an immediately preceding stage, but each up sampling stage also receives input from a corresponding stage on the down sampling side via a skip connection. For example, the output stage, e.g., the eighth stage 682, receives input from both the first stage 652 (via a skip connection 640) and also from the seventh stage 680. It is noted that the second midblock (e.g., fifth stage 670) receives input from the fourth stage 668 without any additional input. The efficient architecture shown in FIG. 6B reduces on-device latency, with little impact on generation quality, compared with a baseline model and also compared with the first variant shown in FIG. 6A. For example, although some features may be dropped with variant two, the result is similar and is calculated more quickly than with variant one.

As shown in the example of FIG. 5, the architecture compression (block 504) is followed by guidance conditioning (block 506). Guidance conditioning may be used in teacher-student frameworks within the machine learning domain. In such frameworks, a more complex or knowledgeable model, referred to as the teacher, facilitates the training of a less complex model, referred to as the student. The goal is for the student to emulate the behavior of the teacher as accurately as possible. The term “guidance” in this context denotes the additional cues or information provided by the teacher to the student during the training phase. This guidance aids the student in making more accurate and expedited predictions. On the other hand, “conditioning” signifies the modulation of the student model's learning trajectory based on the guidance received at the student model, thereby fine-tuning the student model's behavior in alignment with the teacher's input.

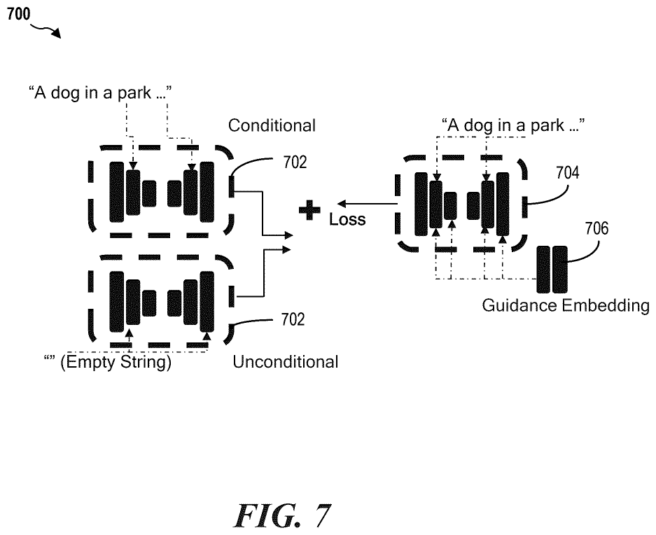

FIG. 7 is a block diagram illustrating an example of guidance conditioning 700, in accordance with various aspects of the present disclosure. As shown in the example of FIG. 7, the guidance conditioning 700 uses a teacher model 702 and a student model 704. The teacher model 702 may receive two prompts, an empty string (e.g., unconditional prompt) and a conditional prompt (shown as “A dog in a park” in the example of FIG. 7). An output based on the unconditional prompt may be referred to as an unconditional output, and an output based on the conditional prompt may be referred to as a conditional output. Additionally, for the student model 704, the prompt is received in addition to guidance embeddings 706 that incorporate a guidance value associated with an output of the teacher model 702 based on the conditional prompt and the unconditional prompt. The guidance embeddings 706 may be based on features extracted from the output of the teacher model 702. In some examples, the student model 704 uses the guidance value to modulate its output, attempting to match the teacher model 702.

A loss function measures the difference between an output of the student model 704 and a sum of the unconditional output and the conditional output of the teacher model 702. The loss is backpropagated through the student model 704 to update weights and/or parameters of the student model 704, moving the student model's 704 output closer to the teacher model's 702 output. In some examples, during a single forward pass, the output of the student model 704 may be aligned with the unconditional output and the conditional output of the teacher model 702. This alignment becomes notably significant downstream, particularly when formulating the loss functions. The guidance conditioning may be performed at each training time step.

The effectiveness of the guidance conditioning 700 may be based on an inherent consistency of the unconditional prompt, which is independent of the conditional prompt. That is, the conditional prompt varies, while the unconditional prompt remains constant, exhibiting a global, consistent behavior. With regard to an output space, a type of scaling is performed, which may be based on a scaling factor conditioned on the guidance value. In some examples, the guidance value is processed through certain layers of the student model 704, such as sine layers, cosine layers, and/or projection layers. The output of the student model 704 may be obtained based on the processing of the guidance value through the various layers. During the intermediate stages, the guidance value serves as a modulator that aligns with the unconditional prompt. That is, the guidance value modulates or scales the output of the student model 704, with a degree of modulation being dictated by the guidance embeddings 706. The modulation may occur in an intermediation activation space of the student model 704, such that a second teacher model is not queried.

In some examples, guidance conditioning may be used for high-level or low-level adjustments. In some such examples, the guidance embedding is added to one of the intermediate activations within a resnet block (current architecture) or any conditioning or modulation layer which processes time-step embeddings may also process guidance value embedding and the downstream layers of that particular block then process the guidance value associated with the guidance embedding. This procedure is not confined to a single block; instead, the process extends across all the blocks within the student model 704. By applying this conditioning across all blocks, the student model 704 achieves a more uniform and comprehensive modulation, such that the adjustments facilitated by the embedding are processed throughout the entire student model 704.

The guidance conditioning 700 described with reference to FIG. 7 may be distinguishable from conventional guidance conditioning and is more like time-step conditioning. In some examples, in contrast to conventional guidance conditioning that uses a signal-to-noise ratio (SNR) across all training steps, the guidance conditioning 700 only uses the SNR loss at a later step in the training process, making the training regimen more adaptive. That is, the use of the SNR loss may be scheduled.

Additionally, conventional guidance conditioning tends to center around specific scenarios, such as the “dog in the park.” In contrast, the guidance conditioning 700 exhibits a broader scope, even during training. Specifically, the guidance conditioning 700 also considers unconditional cases where an empty string is taken as input, and guidance is set to zero. By doing so, the training process urges the student model 704 to align with the behavior of an unconditional output of the teacher model 702, thereby training a more versatile student model 704 that may be capable of handling both conditioned and unconditioned scenarios. This type of training helps retain the unconditioned scenarios, a feature that is not prioritized in conventional guidance conditioning, which solely concentrates on the conditional aspect. The focus of the conventional guidance conditioning on conditioned scenarios may lead to inconsistencies in a vector field, a critical component in the diffusion process. Unconditional training is used to train a baseline diffusion model which improves in obtaining a satisfactory gradient field or score function estimates across the entire space. Training the student model 704 unconditionally mitigates inconsistencies in the vector field.

As shown in the training pipeline 500, step distillation (block 508) is specified after the guidance conditioning (block 506). Step distillation is a process for student models with teacher models. Specifically, step distillation uses model compression to encapsulate the performance of the teacher model within a simpler model structure. This process may be performed in a sequence of training steps or stages, where the order of these steps is specified for effective knowledge transfer from the teacher model to the student model. In some examples, at each step in this sequence, the student model learns from the outputs of the teacher model, which serve as a form of “soft labels” or guidance, aiding the student model in discerning the underlying patterns within the data. A notable feature of step distillation is the reduction in the number of iterations or denoising steps used to attain desirable performance.

In most cases, a specialized loss function is used in step distillation, measuring the disparity between the outputs of the teacher and student models at each step. This loss metric guides the training process, aiding the student model in incrementally improving its performance. For example, in a scenario involving image recognition, a complex teacher model initially trained on a large dataset can guide the training of a simpler student model. Through step distillation, the student model is trained on a subset of the data in a series of steps, each aimed at refining the student model's performance based on the teacher's knowledge. The loss function gauges the performance gap at each step, directing the student model to adjust its parameters for enhanced performance. The culmination of this process is a student model that incrementally learns from the teacher model through a reduced number of iterations, thus becoming proficient in tasks such as image recognition while using fewer computational resources.

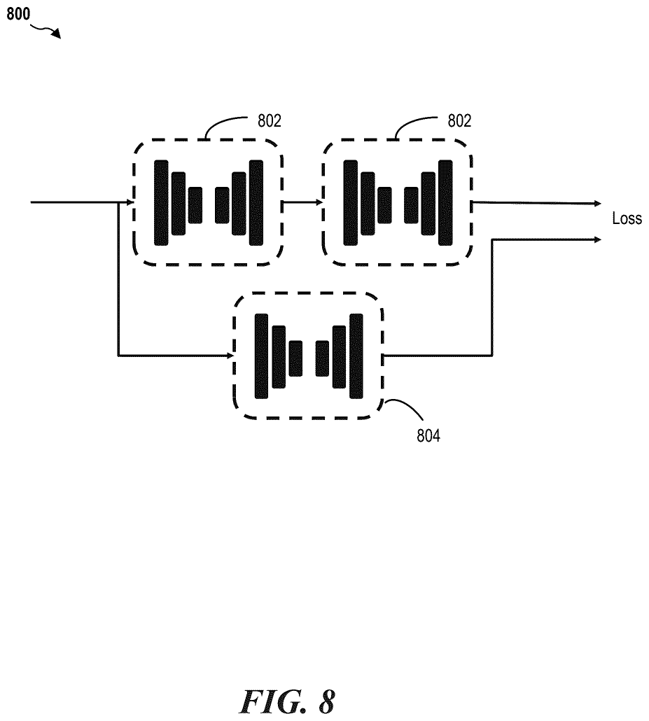

FIG. 8 is a block diagram illustrating an example 800 of step distillation, in accordance with various aspects of the present disclosure. In the example of FIG. 8, two teacher models 802, and one student model 806 are specified. The step distillation shown in the example 800 may be conducted progressively in a multi-stage manner. For example, in a six step process, the process may be initiated with a 24 step teacher, transition to 12 steps, and eventually to six steps. In some examples, the student model 806 may emulate two steps of the teacher models 802, simultaneously. For example, given a current estimate of a latent in the diffusion process, denoted as a current latent Z_{T}, the latent may be updated to a first latent Z_{T-1} and a second latent Z_{T-2}. While the teacher models 802 transition from the current latent Z_{T} to the first latent Z_{T-1} and the second latent Z_{T-2}, the student model 806 forecasts the second latent Z_{T-2}, instead of predicting Z_{T-1} (which would be typically predicted because weights are shared and/or the student model 806 is initialized with weights of the teacher models 802). The step distillation in the example 800 enables the student model 806 to scale its process so that two teacher steps correspond to one student step. The teacher models 802 may be initiated with any number of steps, such as, but not limited to, 24, 48, 50, 100, or 200. In accordance with various aspects of the present disclosure, two steps of the teacher models 802 are distilled into one step of the student model 806. Step distillation reduces computational effort, making the student model 806 more efficient while mimicking the performance of the teacher models 802 over a reduced number of steps.

Conventional classifier free guidance (CFG)-aware step distillation may be performed based on the following function:

$${v}_{t} = ω {v}_{η} ( t , {z}_{t} , c ) - ( ω - 1 ) {v}_{η} ( t , {z}_{t} , ϕ ) . \qquad ( 1 )$$

In Equation 1, v_{η} represents a score function estimation network in a v (velocity) space. The score function estimation network estimates gradients of log-likelihood with in diffusion models Additionally, t represents a time step within the diffusion process, zₜ represents the intermediate latent at time step t within a diffusion process, c represents text-conditioning for sampling from a conditional diffusion model or a score estimate, and ϕ represents a null-conditioning for sampling from an unconditional diffusion model or score estimate. In the context of step distillation, CFG guides training of both teacher and student models. Guidance occurs by comparing the outcomes of the teacher and student models at each time step t within the diffusion process. In Equation 1, the score function estimation network may use text-conditioning c and/or null-conditioning ϕ to process the intermediate latent variable zₜ. A weighting factor ω may adjust the contribution of the conditional and unconditional components in the estimation. For step distillation the teacher may be unrolled for two sampling steps using an ordinary differential equation (ODE) or a stochastic differential equation (SDE) solver within reverse process and the guidance conditioned student model may be forced to match the teacher's higher number of steps within fewer steps of student.

Conventional CFG-aware distillation may execute two forward passes in each iteration, which may increase latency. The latency may be further increased when a guidance conditioned model is used as the teacher model during step distillation, as the guidance conditioned model leads to an accumulation of errors across successive stages, thereby impacting the accuracy of the distillation process. Furthermore, the implementation of guidance conditioning is associated with a performance drop. Conventional systems may use conditional sampling for both guidance and step distillation. However, conventional systems overlook the advantages brought forth by unconditional sampling. Given that unconditional sampling finds its application within CFG and has implications on overall coverage and the performance of the network, especially in the later stages of training, it may be desirable to retain unconditional sampling throughout all stages. In addition to these challenges, a common practice in conventional diffusion models is the use of clipping in the input space to the range (−1,1). However, when this clipping occurs within two denoising diffusion implicit model (DDIM) steps of the teacher, the default equations fall into inconsistency. This inconsistency poses a challenge to achieving a reliable and efficient distillation process. These outlined problems underscore the complexities faced in the conventional CFG-aware distillation process.

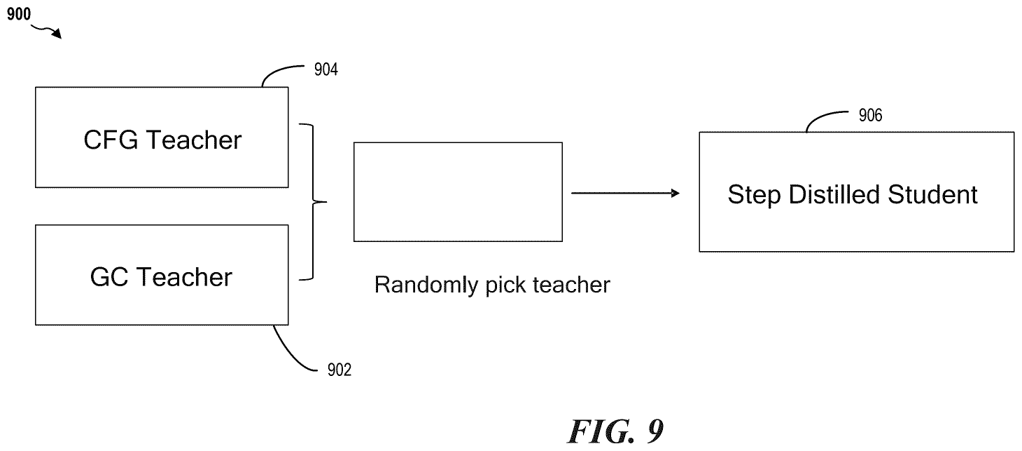

Various aspects of the present disclosure are directed to improving guided student distillation by reducing a time associated with the learning process while maintaining a level of accuracy for the student model. FIG. 9 is a block diagram illustrating an example 900 of a step distillation process, in accordance with various aspects of the present disclosure. In the example 900 of FIG. 9, the step distillation process alternates between a guidance conditioned teacher model 902 (using one UNet model per step) and a CFG-aware teacher model 904 (using two UNet models per step) during the training process. By learning from the CFG-aware teacher model 904, the step distilled student model 906 avoids error accumulation across multiple stages, which may occur in conventional step distillation processes.

In some examples, clipped step distillation may be specified to clip the input space, denoted by x within the teacher's target to maintain consistency over the teacher's two steps, as delineated by the equation transformation. In Equation 2, α and σ represent time-dependent noise-level coefficients which control the forward (and reverse) process within diffusion models captured by a latent z as a function of the input space x and noise ∈ defined by zₜ=αₜx₀+σₜ∈, and

$${ϵ}_{t} = {σ}_{t} {z}_{t} + {α}_{t} {v}_{t} \to {ϵ}_{t} = \frac{{z}_{t} - {α}_{t} {x}_{t}}{{σ}_{t}} \qquad ( 2 )$$

Additionally, unconditional training for guidance conditioning may be maintained and step distillation with dropout may be introduced. This strategy may align the overall behavior of the step distilled student model 906 with that of both the CFG teacher and the GC teacher, thereby improving performance and preventing mode-collapse.

In some examples, signal-to-noise ratio (SNR) loss may be used for guidance conditioning. In such examples, instead of applying SNR loss across all steps, a training time schedule may be specified to incorporate SNR weighting, such that the step distilled student model 906 is consistent with the default model training during the early stages of distillation, thereby obtaining a gradual and structured learning curve. Specifically, the step distillation process described in the example 900 maintains unconditional training throughout, which improves regularization and overall model behavior. This process diverges from conventional step distillation processes, which often apply SNR weighting. SNR weighting may shift focus toward a data space, especially early in the diffusion process. Still, SNR weighting may lead to undesired model behavior if not managed carefully. As discussed, various aspects of the present disclosure implement a learning schedule instead of applying the conventional SNR loss. In some examples, the step distillation process initially abstains from applying the SNR loss, allowing the model to focus on each stage of the diffusion process uniformly. As training progresses, the SNR loss is gradually incorporated, shifting the model's focus more towards the data space. This phased approach, which is similar to curriculum learning, aims to balance model generalization against quality retention, a balance not effectively struck in existing methods.

Lastly, end-to-end fine-tuning of efficient architectures is specified to obtain a consistent score function estimation and to refine SNR loss towards a tail end of the training process. Post-distillation, this fine-tuning process regularizes the step distilled student model 906, rendering the step distilled student model 906 as a reliable and consistent score function estimator, thus improving performance and accuracy. That is, architectural compression and guidance conditioning, while instrumental, can sometimes transfer undesired artifacts from the teacher to the student model. To mitigate the transfer of undesired artifacts, end-to-end fine-tuning may be performed at each stage after architectural distillation and guidance conditioning, with a slight emphasis on unconditional sampling. This fine-tuning process may manage a vector field, avoid the transfer of any undesired traits, and promote a more reliable and efficient learning process.

The step distillation process described in the example 900 may diminish hyperparameter sensitivity and reduce overall training necessities. This modification leads to a better-behaved step distillation, as mentioned, making the training regimen more manageable and efficient. In contrast to conventional step distillation processes, various aspects of the present disclosure use a unique combination of the CFG-aware teacher model 904 with the guided step distilled student model 906. This pairing addresses and rectifies inconsistencies observed during conventional step distillation at training time. To address these inconsistencies, a transition to the X-space is implemented, where necessary corrections are made before reverting back to the Z-space. This step in the distillation process rectifies misalignments, thus contributing to a more stable training process.

As discussed, the specific implementations of training processes described with regard to the training pipeline 500 differ from conventional training processes. For example, a layer-wise distillation may be specified for the architecture compression (block 502). The layer-based distillation may be used for a guided optimization pathway. In contrast, conventional training systems attempt to prune the architecture in an end-to-end fashion. Additionally, in conventional training systems, a performance drop is observed when implementing guidance conditioning, which may propagate into the step distillation phase. To mitigate the performance drop, despite the student model being a guidance-conditioned student—meaning it runs only one UNet per iteration—the target for the initial step distillation is adjusted to consider a teacher model without guidance conditioning. This adjustment aids in avoiding accumulation of errors across the sequential training stages, thus minimizing a reduction in accuracy. Additionally, in some examples, a teacher model without guidance conditioning is associated with two UNet forward passes per iteration, in contrast to the student model that is only associated with one UNet forward pass per iteration.

Various aspects of the present disclosure may also improve training and inference of control neural network. A ControlNet may be an example of a control neural network. The control neural network is a neural network that controls a diffusion model by integrating additional semantic guidance into text-to-image diffusion models. For ease of explanation the various aspects of discussed below will use the example of a ControNet. Aspects of the present disclosure are not limited to the ControlNet, as other types of control neural networks may be used. Unlike conventional diffusion models, ControlNet facilitates the generation of images with a higher level of detail and accuracy, by leveraging supplementary guidance cues such as edge information, depth perception, segmentation maps, and/or pose data. ControlNet may be used for various tasks or applications, such as, but not limited to, mobile cameras, data generation, image generation, video generation, and/or image editing.

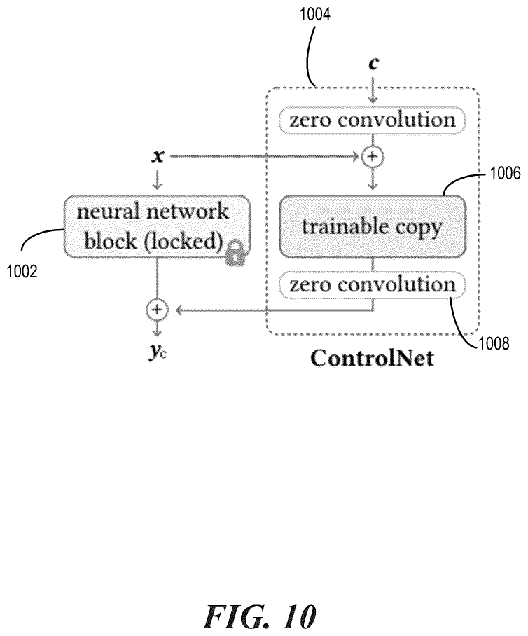

FIG. 10 is a block diagram of a ControlNet architecture 1000, in accordance with various aspects of the present disclosure. In the example of FIG. 10, the ControlNet architecture 1000 includes a diffusion model 1002. The diffusion model 1002 may be pre-trained. The diffusion model 1002 may be a baseline diffusion model, where each stage of the diffusion model 1002 is represented by a distinct neural network block. In some examples, a ControlNet model 1004 receives an input x to the diffusion model 1002 and combines the input x with an additional input c that serves as a conditioning factor for the final image creation (e.g., final output y). This additional input c could range from simple scribbles to comprehensive depth or edge maps. The combined inputs may be received at a trainable copy 1006 of the ControlNet model 1004. The output of the trainable copy 1006 may modulate or update the output y from the diffusion model 1002 before the output y is passed down to the subsequent layer. The additional input c and the output of the trainable copy 1006 may be processed by a zero convolution layer 1008, where instead of initializing a convolutional layer with random weights, all weights or parameters are initialized with zero. By conditioning on these inputs (x and c), the ControlNet model 1004 guides the diffusion model 1002 to produce images that closely align with the additional input c.

The training of the ControlNet model 1004 is non-intrusive with respect to the diffusion model 1002. During the training phase, the ControlNet model 1004 does not alter the weights or parameters of the diffusion model 1002. This strategy maintains the foundational characteristics of the diffusion model 1002 while the ControlNet model 1004 contributes its modulation to enhance the output, guiding the generation process in a controlled manner.

The ControlNet model 1004 is structured to piggyback on a baseline diffusion model 1002, ensuring that the text-to-image generation capability remains intact without altering the baseline diffusion model 1002. Instead, the ControlNet model 1004 enhances the generation process by processing additional information. Because the original weights of the baseline diffusion model 1002 are frozen, the ControlNet model 1004 essentially operates alongside, leveraging the existing architecture without directly modifying the baseline diffusion model 1002.

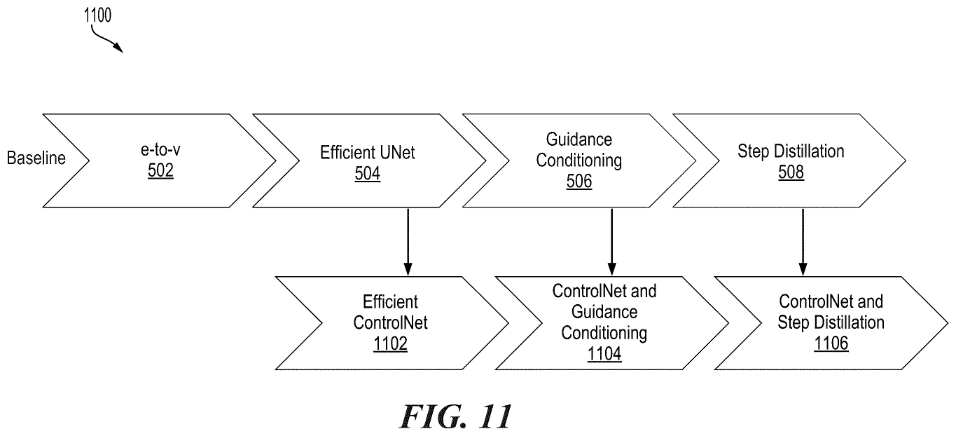

FIG. 11 is a block diagram illustrating an example of a ControlNet training pipeline 1100, in accordance with various aspects of the present disclosure. In the example of FIG. 11, the ControlNet training pipeline 1100 piggybacks off of the stable diffusion training pipeline 500 described with reference to FIG. 5. As shown in FIG. 11, each stage of the ControlNet training pipeline 1100, also referred to as ControlNet distillation, corresponds to a UNet from the stable diffusion training pipeline 500. The process begins at block 1102 with a distilled, compressed UNet from which layers may be removed or replaced to initiate a new efficient architecture version of ControlNet. This efficient architecture may perform the standard functions of ControlNet. In some aspects, the efficient ControlNet architecture at block 1102 may be based on a model trained from scratch or initiated from an existing UNet architecture. In some examples, after training the efficient UNet at block 504, an efficient ControlNet is trained at block 1102. By using a compressed UNet architecture, the transition is made towards an efficient or compressed ControlNet. This streamlined version aims to maintain the functionality of the standard ControlNet while operating on a more efficient framework.

As shown in FIG. 11, for guidance conditioning, a guidance-conditioned student version (block 506) of the UNet or the baseline diffusion model is used. At block 1104, the ControlNet from the previous stage (block 1102) is taken and initialized with guidance conditioning exclusively for the ControlNet model. Because the UNet is already guidance-conditioned, minimal training may be specified to obtain a guidance-conditioned ControlNet that mimics the behavior of a conventional ControlNet.

In some cases, four forward passes may be specified for a conventional ControlNet-two for ControlNet and two for UNet, each with and without text embedding. However, in accordance with various aspects of the present disclosure, based on the training pipeline 1100, a single forward pass through ControlNet may emulate two forward passes of the teacher model. This efficiency is a step towards reducing computational load while retaining the desired output quality.

At each stage of the ControlNet training pipeline 1100, the output from the previous stage's ControlNet and the UNet from the corresponding stage in the stable diffusion training pipeline 500 are taken. If guidance conditioning is being applied, the guidance-conditioned unit is taken, and the ControlNet from the previous stage is fine-tuned. Similarly, for step distillation at block 1106, the step-distilled unit (block 508) and the guidance-conditioned ControlNet are taken and fine-tuned to mimic the desired behavior.

The goal of the ControlNet training pipeline 1100, regardless of guidance conditioning and step distillation, is for the ControlNet to emulate the behavior of the baseline diffusion model. The process is depicted as taking the final checkpoint of a particular stage of the stable diffusion training pipeline 500, and the ControlNet taking the output from the previous stage in the ControlNet training pipeline 1100.

It is noted that the stable diffusion model is referred to frequently throughout this description. The present disclosure, however, contemplates any diffusion model and is not limited the stable diffusion model or any other specific diffusion model.

FIG. 12 is a flow diagram illustrating an example of a process 1200 for training a diffusion model, in accordance with aspects of the present disclosure. The process 1200 may be performed by an SOC 100 as described with reference to FIG. 1. As shown in FIG. 12, the process 1200 begins at block 1202 by compressing the diffusion model by removing one or more model parameters and/or one or more giga multiply-accumulate operations (GMACs). At block 1204, the process 1200 performs guidance conditioning to train the compressed diffusion model, the guidance conditioning combining a conditional output and an unconditional output from respective teacher models. At block 1206, the process 1200 performs, after the guidance conditioning, step distillation on the compressed diffusion model.

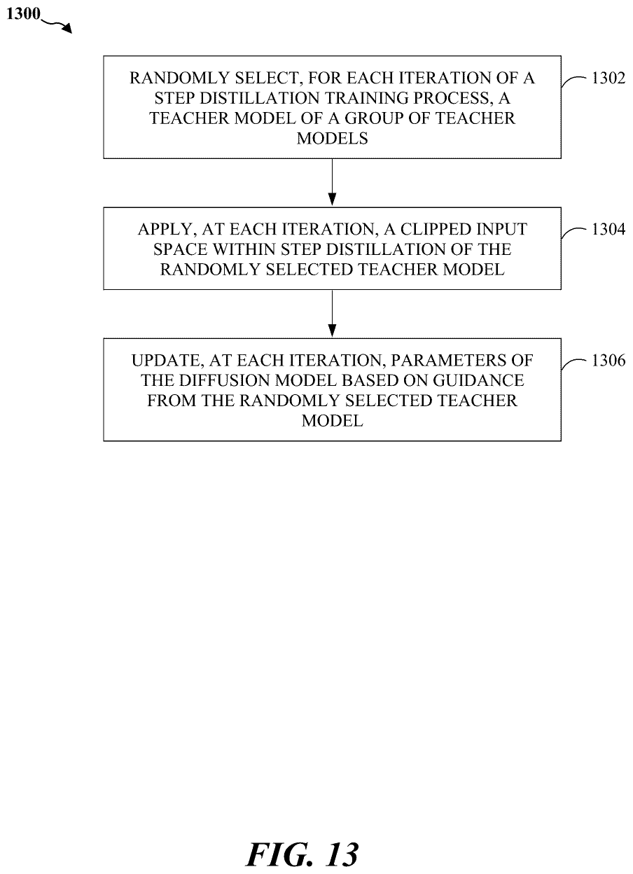

FIG. 13 is a flow diagram illustrating an example of a process 1300 for a CFG-aware step distillation process, in accordance with aspects of the present disclosure. The process 1300 may be performed by an SOC 100 as described with reference to FIG. 1. As shown in FIG. 13, the process 1300 begins at block 1302 by randomly selecting, for each iteration of a step distillation training process, a teacher model of a group of teacher models. At block 1304, the process 1300 applies, at each iteration, a clipped input space within step distillation of the randomly selected teacher model. At block 1306, the process 1300 updates, at each iteration, parameters of the diffusion model based on guidance from the randomly selected teacher model.

FIG. 14 is a flow diagram illustrating an example of a process 1400 for training a ControlNet model, in accordance with aspects of the present disclosure. The process 1400 may be performed by an SOC 100 as described with reference to FIG. 1. As shown in FIG. 14, the process 1400 begins at block 1402 by initializing a baseline diffusion model for training the control neural network, each stage of a control neural network training pipeline corresponding to an element of the baseline diffusion model. At block 1404, the process 1400 trains, the control neural network, in a stage-wise manner, each stage of the control neural network training pipeline receiving an input from a previous stage of the control neural network training pipeline and the corresponding element of the diffusion model.

Implementation examples are described in the following numbered clauses:
Clause 1. A method for training a control neural network, comprising: initializing a baseline diffusion model for training the control neural network, each stage of a control neural network training pipeline corresponding to an element of the baseline diffusion model; and training, the control neural network, in a stage-wise manner, each stage of the control neural network training pipeline receiving an input from a previous stage of the control neural network training pipeline and the corresponding element of the diffusion model.
Clause 2. The method of Clause 1, wherein the control neural network training pipeline includes: a control neural network architecture compression stage corresponding to a compressed UNet architecture of the baseline diffusion model; a guidance conditioning stage corresponding to a guidance conditioned student model of the baseline diffusion model; and a step distillation stage corresponding to a step distilled student model of the baseline diffusion model.
Clause 3. The method of any one of Clauses 1-2, wherein weights and parameters of the baseline diffusion model are maintained during the training of the control neural network.
Clause 4. The method of any one of Clauses 1-3, wherein the control neural network is trained to emulate behavior of the baseline diffusion model in a single forward pass.
Clause 5. The method of any one of Clauses 1-4, wherein: the control neural network receives a first input received at the baseline model and an auxiliary input; the control neural network generates a first output based on receiving the first input and the auxiliary input; and the first output modulates a second output of the baseline diffusion model.
Clause 6. The method of any one of Clauses 1-5, wherein the baseline diffusion model is trained prior to training the control neural network.
Clause 7. The method of any one of Clauses 1-6, wherein a baseline diffusion model training pipeline includes, at least, a compression stage, a guidance conditioning stage, and a step distillation stage.
Clause 8. An apparatus comprising one or more processors, one or more memories coupled with the one or more processors, and storing instructions operable, when executed by the one or more processors to cause the apparatus to perform any one of Clauses 1 through 7.
Clause 9. An apparatus comprising at least one means for performing any one of Clauses 1 through 7.
Clause 10. A computer program comprising code for causing an apparatus to perform any one of Clauses 1 through 7.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-Ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. An apparatus for training a control neural network, comprising:
one or more processors; and
one or more memories coupled with the one or more processors and storing instructions operable, when executed by the one or more processors, to cause the apparatus to:
initialize a baseline diffusion model for training the control neural network, each stage of a control neural network training pipeline corresponding to an element of the baseline diffusion model; and
train, the control neural network, in a stage-wise manner, each stage of the control neural network training pipeline receiving an input from a previous stage of the control neural network training pipeline and the corresponding element of the diffusion model.

2. The apparatus of claim 1, wherein the control neural network training pipeline includes:
a control neural network architecture compression stage corresponding to a compressed UNet architecture of the baseline diffusion model;
a guidance conditioning stage corresponding to a guidance conditioned student model of the baseline diffusion model; and
a step distillation stage corresponding to a step distilled student model of the baseline diffusion model.

3. The apparatus of claim 1, wherein weights and parameters of the baseline diffusion model are maintained during the training of the control neural network.

4. The apparatus of claim 1, wherein the control neural network is trained to emulate behavior of the baseline diffusion model in a single forward pass.

5. The apparatus of claim 1, wherein:
the control neural network receives a first input received at the baseline model and an auxiliary input;
the control neural network generates a first output based on receiving the first input and the auxiliary input; and
the first output modulates a second output of the baseline diffusion model.

6. The apparatus of claim 1, wherein the baseline diffusion model is trained prior to training the control neural network.

7. The apparatus of claim 1, wherein a baseline diffusion model training pipeline includes, at least, a compression stage, a guidance conditioning stage, and a step distillation stage.

8. A method for training a control neural network, comprising:
initializing a baseline diffusion model for training the control neural network, each stage of a control neural network training pipeline corresponding to an element of the baseline diffusion model; and
training, the control neural network, in a stage-wise manner, each stage of the control neural network training pipeline receiving an input from a previous stage of the control neural network training pipeline and the corresponding element of the diffusion model.

9. The method of claim 8, wherein the control neural network training pipeline includes:
a control neural network architecture compression stage corresponding to a compressed UNet architecture of the baseline diffusion model;
a guidance conditioning stage corresponding to a guidance conditioned student model of the baseline diffusion model; and
a step distillation stage corresponding to a step distilled student model of the baseline diffusion model.

10. The method of claim 8, wherein weights and parameters of the baseline diffusion model are maintained during the training of the control neural network.

11. The method of claim 8, wherein the control neural network is trained to emulate behavior of the baseline diffusion model in a single forward pass.

12. The method of claim 8, wherein:
the control neural network receives a first input received at the baseline model and an auxiliary input;
the control neural network generates a first output based on receiving the first input and the auxiliary input; and
the first output modulates a second output of the baseline diffusion model.

13. The method of claim 8, wherein the baseline diffusion model is trained prior to training the control neural network.

14. The method of claim 8, wherein a baseline diffusion model training pipeline includes, at least, a compression stage, a guidance conditioning stage, and a step distillation stage.

15. A non-transitory computer-readable medium having program code recorded thereon for training a control neural network, the program code executed by a processor and comprising:
program code to initialize a baseline diffusion model for training the control neural network, each stage of a control neural network training pipeline corresponding to an element of the baseline diffusion model; and
program code to train, the control neural network, in a stage-wise manner, each stage of the control neural network training pipeline receiving an input from a previous stage of the control neural network training pipeline and the corresponding element of the diffusion model.

16. The non-transitory computer-readable medium of claim 15, wherein the control neural network training pipeline includes:
a control neural network architecture compression stage corresponding to a compressed UNet architecture of the baseline diffusion model;
a guidance conditioning stage corresponding to a guidance conditioned student model of the baseline diffusion model; and
a step distillation stage corresponding to a step distilled student model of the baseline diffusion model.

17. The non-transitory computer-readable medium of claim 15, wherein weights and parameters of the baseline diffusion model are maintained during the training of the control neural network.

18. The non-transitory computer-readable medium of claim 15, wherein the control neural network is trained to emulate behavior of the baseline diffusion model in a single forward pass.

19. The non-transitory computer-readable medium of claim 15, wherein:
the control neural network receives a first input received at the baseline model and an auxiliary input;
the control neural network generates a first output based on receiving the first input and the auxiliary input; and
the first output modulates a second output of the baseline diffusion model.

20. The non-transitory computer-readable medium of claim 15, wherein the baseline diffusion model is trained prior to training the control neural network.

21. The non-transitory computer-readable medium of claim 15, wherein a baseline diffusion model training pipeline includes, at least, a compression stage, a guidance conditioning stage, and a step distillation stage.

22. An apparatus for training a control neural network, comprising:
means for initializing a baseline diffusion model for training the control neural network, each stage of a control neural network training pipeline corresponding to an element of the baseline diffusion model; and
means for training, the control neural network, in a stage-wise manner, each stage of the control neural network training pipeline receiving an input from a previous stage of the control neural network training pipeline and the corresponding element of the diffusion model.

23. The apparatus of claim 22, wherein the control neural network training pipeline includes:
a control neural network architecture compression stage corresponding to a compressed UNet architecture of the baseline diffusion model;
a guidance conditioning stage corresponding to a guidance conditioned student model of the baseline diffusion model; and
a step distillation stage corresponding to a step distilled student model of the baseline diffusion model.

24. The apparatus of claim 22, wherein weights and parameters of the baseline diffusion model are maintained during the training of the control neural network.

25. The apparatus of claim 22, wherein the control neural network is trained to emulate behavior of the baseline diffusion model in a single forward pass.

26. The apparatus of claim 22, wherein:
the control neural network receives a first input received at the baseline model and an auxiliary input;
the control neural network generates a first output based on receiving the first input and the auxiliary input; and
the first output modulates a second output of the baseline diffusion model.

27. The apparatus of claim 22, wherein the baseline diffusion model is trained prior to training the control neural network.

28. The apparatus of claim 22, wherein a baseline diffusion model training pipeline includes, at least, a compression stage, a guidance conditioning stage, and a step distillation stage.
